(19) United States
(12) Patent Application Publication
(10) Pub. No.: US 2013/0195009 A1
(43) Pub. Date: Aug. 1, 2013

(54) CS/PS COORDINATION FOR CSFB/SRVCC

(71) Applicant: TELEFONAKTIEBOLAGET LM ERICSSON (publ), Stockholm (SE)

(72) Inventors: Peter RAMLE, Molnlycke (SE); Gunnar RYDNELL, Vastra Frolunda (SE)

(73) Assignee: TELEFONAKTIEBOLAGET LM ERICSSON (publ), Stockholm (SE)

(21) Appl. No.: 13/672,772

(22) Filed: Nov. 9, 2012

Related U.S. Application Data
(60) Provisional application No. 61/592,621, filed on Jan. 31, 2012.

(51) Int. Cl. H04W 40/34

(52) U.S. Cl. CPC H04W 40/34
USPC 370/328

(57) ABSTRACT

The embodiments herein relate to a method in an SGSN (313) in a communications network (300). A user equipment (301) has moved from a source PS domain to a CS domain due to SRVCC or due to CSFB. The SGSN (313) determines that the SGSN (313) comprises information about a CS/PS coordination indicator and a CS operator indicator. The SGSN (313) evaluates whether a target PS operator is the same as a CS operator when the SGSN (313) is determined to comprises the CS/PS coordination indicator and the CS operator indicator. The SGSN (313) determines that the user equipment (301) shall remain connected to the SGSN (313) in the target PS domain when the CS operator is the same as the target PS operator. The SGSN (313) sends a reject command to the controller node (315) when the CS operator is different from the target PS operator.

### TECHNICAL FIELD

Embodiments herein relate generally to a Serving General packet radio service (GPRS) Support Node (SGSN), a method in the SGSN, a Mobility Management Entity (MME) and a method in the MME. More particularly the embodiments herein relate to handling connections to a user equipment.

### BACKGROUND

In a typical cellular network, also referred to as a communications system, communications network or telecommunications network, a user equipment, communicates via a Radio Access Network (RAN) to one or more Core Networks (CNs).

A user equipment is a device by which a subscriber may access services offered by an operator's network and services outside operator's network to which the operators radio access network and core network provide access, e.g. access to the Internet. An operator may be e.g. a telephone service provider company. The user equipment may be for example communication devices such as user equipments, mobile telephones, cellular telephones, smart phones, tablet computers or laptops with wireless capability. The user equipments may be portable, pocket storable, hand held, computer comprised, or vehicle mounted mobile devices, enabled to communicate voice and/or data, via the radio access network, with another entity, such as another user equipment or a server.

User equipments are enabled to communicate wirelessly in the communications network. The communication may be performed e.g. between two user equipments, between a user equipment and a regular telephone and/or between the user equipment and a server via the radio access network and possibly one or more core networks, comprised within the communications network.

The radio access network covers a geographical area which is divided into cell areas, with each cell area being served by a Base Station (BS), e.g. a Radio Base Station (RBS), which in some radio access networks is also called evolved NodeB (eNB), NodeB, B node or base station. A cell is a geographical area where radio coverage is provided by the radio base station at a base station site. The base stations communicate with the user equipments within range of the base stations. The user equipment may be located in a source cell. When the user equipment is moving, it may go from being with coverage of the source cell to a target cell. In some scenarios, there the user equipment may have a plurality of target cells, of which at least one will be the selected target cell.

Circuit Switching (CS) is a methodology of implementing the communications network in which two network nodes establish a dedicated communications channel (circuit) through the communications network before the network nodes may communicate. The circuit functions as if the nodes were physically connected as with an electrical circuit. An example of a circuit switched network is the Public Switched Telephone Network (PSTN).

Circuit switching contrasts with Packet Switching (PS) which divides the data to be transmitted into small units, called packets, transmitted through the network independently. Packet switching shares available network bandwidth between multiple communication sessions. Packet switching features delivery of variable bit rate data streams (sequences of packets) over a shared network. When traversing network adapters, switches, routers and other network nodes, packets are buffered and queued, resulting in variable delay and throughput depending on the traffic load in the network.

Long Term Evolution (LTE) is a standard for wireless communication of high-speed data for user equipments. Unlike previous telecommunications standards comprising e.g. Global System for Mobile Communications (GSM) and Universal Mobile Telecommunications System (UMTS), LTE does not have a circuit switched domain to handle voice calls in the traditional second generation/third generation (2G/3G) way. Instead LTE is an all-IP system providing an end-to-end IP connection from the user equipment to the core network and out again, and supports only packet switching with its all-IP network. Therefore, voice service continuity is not guaranteed when a Voice over IP (VoIP) user equipment roams between the LTE coverage area and other wireless networks—and it is a significant challenge to deliver voice over LTE networks. One approach is to use Voice over LTE (VoLTE). VoLTE is a system for providing a unified format of voice traffic on LTE.

When the user equipment is camping in LTE there are two methods for providing voice service to the user equipment: Circuit Switched FallBack (CSFB) from LTE to 2G/3G or VoLTE in combination with Single Radio Voice Call Continuity (SRVCC). In any of these cases the user equipment may end up being connected to a Mobile Switching Center (MSC), given voice service over CS in 2G/3G. The MSC connects the landline PSTN system to the communication system. The base station routes the communications to the MSC via a serving Base Station Controller (BSC). The MSC routes the communications to another subscribing wireless unit via a BSC/base station path or via the PSTN/Internet/other network to the terminating destination. Between MSCs, circuit connections provide the handover mechanism that service calls as user equipments roam from one service zone to another. The MSC may be seen as an equivalent with an exchange in a fixed network. When considering a LTE user equipment, this user equipment will certainly have PS service capability for surfing the internet etc. In some cases, depending on the user equipment type and the network capability, the user equipment may have simultaneous voice and data service invoked. It is then a basic requirement that the user equipment shall receive voice and data service from the same operator.

CSFB defines a mechanism for using a CS network to provide voice services alongside of an LTE network, i.e. a PS network. Through the CSFB, the user equipment is directed to Wideband Code Division Multiple Access (WCDMA)/GSM to initiate or take a voice call, and the call remains in the CS domain until it is completed, and returns to LTE when finished.

Using the inter-technology mobility capabilities of LTE, CSFB allows user equipments to transition to a legacy CS network to receive voice services and then return to LTE when finished. CSFB only provides support for voice and Short Message Service (SMS). SRVCC is an LTE functionality that provides continuity between the Internet Protocol (IP) Multimedia Subsystem (IMS) over PS access and CS access for calls that are anchored in IMS when the user equipment is capable of transmitting/receiving on only one of those access networks at a given time.

A problem with the existing solution is that in some configurations a voice and data user equipment may end up receiving service from different operators in the PS and the CS domain. How can this happen?

For CSFB or SRVCC it may happen when the target network is a shared network. A shared network is a network where radio network controllers and base stations are shared by one or more operators. In contrast, only one operator owns both the radio network controllers and base stations in an unshared network. The situation is that the user equipment is camping from the start in LTE, i.e. in a PS network and its source network, it is connected to a source MME, and may be in IDLE or CONNECTED mode. A CSFB or SRVCC without PS HandOver (HO) is triggered.

For CSFB or SRVCC for Roaming InComing (RIC) user equipments, there is a problem when the target network is a shared network and for non-PS HO in a Dual Transfer Mode (DTM) case when the user equipment makes a Routing Area Update (RAU). It is also shown in FIG. 1. DTM mentioned above is a protocol that enables simultaneous transfer of CS voice and PS data over the same radio channel. A roaming incoming user equipment is a user equipment with agreements with both sharing operators, and a Single-RIC (S-RIC) is a roaming incoming user equipment to which only one operator has a roaming agreement. FIG. 1 illustrates a communications network 100 comprising a user equipment 101, a MME A 105, a MSC A 107, a SGSN B 110, a SGSN A 113, a BSC/RNC 115, and a base station 120. As mentioned above, the base station 120 may be for example an eNB. RNC is an abbreviation for Radio Network Controller. The letter A refers to an operator A and the letter B refers to an operator B. As illustrated in FIG. 1, the user equipment 101 moves from LTE to UTRAN/GERAN, i.e. a SCFB or a SRVCC takes place. UTRAN is short for Universal Terrestrial Radio Access Network and GERAN is short for GSM EDGE Radio Access Network. EDGE is short for Enhanced Data rates for GSM Evolution. The MME A 105 selects MSC A 107 to which the user equipment 101 connects and receives voice service. But the user equipment 101 may then, in some cases discussed above, get connected to the SGSN B 110 for data service.

The following sequence shows an example of how a voice and data user equipment may end up receiving service from different operators in the PS and the CS domain:

Step 101a

For CSFB a target cell is selected at the latest Tracking Area Update (TAU) or Attach. The MME A 105 then connects to an appropriate MSC A 107, which serves the selected target cell and Public Land Mobile Network (PLMN).

### Step 101b

For SRVCC the eNB 120 will select a target cell and PLMN in 2G/3G and indicate the selection to the MME A 105. The MME A 105 connects to an appropriate MSC A 107, which serves the selected target cell and PLMN.

### Step 103

The user equipment 101 is handed over to the target cell or reselects the target cell. At the target cell the user equipment 101 connects to the MSC A 107.

### Step 104

The use user equipment 101 sends RAU including the Packet Temporary Mobile Subscriber Identity (P-TMSI) comprising the Network Resource identifier (NRI), which the user equipment 101 has calculated based on the MME Code (MMEC). Note that IRAT HO, a.k.a. PS HO procedure, is not performed. Note also that, in this example, DTM is supported in both the user equipment 101 and in the communications network 100.

### Step 105

The RNC/BSC 115 uses, in this example, the NRI to select the SGSN A 113 to which it may send the RAU.

### Step 106

In this example the user equipment 101 is a RIC, the SGSN A 113 will therefore not accept the RAU but sends the Reroute Command back to the RNC/BSC 115 to require CS/PS Coordination.

### Step 107

For roaming user equipments 101 with agreements with both sharing operators, i.e. RICs, the BSC/RNC may then select a different SGSN B 110 belonging to another operator B and the user equipment 101 may end up connected to different operators in the CS domain and in the PS domain, e.g. operators A and B.

Note that there is no problem when the user equipment 101 is the operators own user equipment—then the SGSN A 113 will keep it. It is neither any problem with a roaming user equipment 101 to which only one operator has a roaming agreement, i.e. an S-RIC, —then the user equipment 101 will finally anyway end up at the only possible operator which also should have been selected for the CS domain.

FIG. 2 is a flow chart illustrating embodiments of the problems with the existing methods. The method comprises the following steps, which steps may be performed in any suitable order:

### Step 201

The SGSN A 113 receives a RAU from the RNC/BSC 115.

### Step 202

The SGSN A 113 checks whether the user equipment 101 is a roaming user equipment or not, i.e. whether the user equipment 101 is a RIC or an S-RIC.

If the SGSN A 113 determines that the user equipment 101 is not a roaming user equipment, indicated with “no” in FIG. 2, the method proceeds to step 203. If the SGSN A 113 determines that the user equipment 101 is a roaming user equipment, indicated with “yes” in FIG. 2, the method proceeds to step 205.

### Step 203

When the SGSN A 113 has determined that the user equipment 101 is not a roaming user equipment, the SGSN A 113 decides to keep the user equipment 101. In this case, there is no problem. Note that the term “old” and “source” may be used to refer to the same node. The context request/response is done in an earlier step to be able to get the IMSI and thereby determine if the user equipment 101 is an own user equipment or a roaming user equipment.

### Step 205

When the SGSN A 113 has determined that the user equipment 101 is a roaming user equipment in step 202, the SGSN A 113 sends a reroute command to the RNC/BSC 115 comprising the IMSI. IMSI is short for international Mobile Subscriber Identity and is a unique identification associated with the user equipment 101.

### Step 206

The RNC/BSC 115 performs hashing of the IMSI, and the RNC/BSC 115 selects another SGSN B 110 based on the result of the IMSI hashing.

### Step 207

The other SGSN B 115 checks whether there is a roaming agreement with this user equipments 101 operator. If there is no roaming agreement, indicated with “no” in FIG. 2, the method goes back to step 205. If there is a roaming agreement, indicated with “yes” in FIG. 2, the method proceeds to step 208.

### Step 208

When there is a roaming agreement with the user equipments 101 operator, the other SGSN B 115 keeps the user equipment 101 and sends a context request to the source MME A 105 and receives a context response back from the source MME A 105.

### Step 209

It is then determined whether the operator of the SGSN B 110 and the operator of the MSC A 107 operator are the same. If the operators are the same, indicated with “yes” in FIG. 2, then there is no problem. If the operators are different, indicated with “no” in FIG. 2, the user equipment 101 is a RIC having a roaming agreement with both operators. Since the PS operator is different from the CS operator, the user equipment 101 ends up receiving service from different operators in the PS and the CS domain.

### SUMMARY

An object of embodiments herein is therefore to obviate at least one of the above disadvantages and to provide an improved and simplified communications network.

According to a first aspect, the object is achieved by a method in an SGSN for handling connections to a user equipment. The SGSN is connected to the user equipment. The user equipment has moved from a source PS domain to a CS domain due to a SRVCC or due to a CSFB. A target PS domain is associated with a target PS operator and the CS domain is associated with a CS operator. When the SGSN comprises information about a CS/PS coordination indicator and a CS operator indicator, the SGSN determines that the user equipment shall remain connected to the SGSN in the target PS domain when the CS operator is the same as the target PS operator.

According to a second aspect, the object is achieved by a method in a MME for handling connections to a user equipment. The MME is associated with a source PS operator and with a user equipment. The MME comprises information about the CS/PS coordination indicator and the CS operator indicator. The MME receives a context request from the SGSN. The MME sends a context response to the SGSN in response to the context request. The context response comprises the CS/PS coordination indicator and the CS operator indicator enabling the SGSN to handle connections to the user equipment.

According to a third aspect, the object is achieved by an SGSN for handling connections to a user equipment. The SGSN is configured to be connected to a user equipment. The user equipment is configured to be moved from the source PS domain to the CS domain due to the SRVCC or due to the CSFB. The target PS domain is associated with a target PS operator and the CS domain is associated with the CS operator. The SGSN comprises a determining unit which is configured to, when the SGSN comprises information about a CS/PS coordination indicator and a CS operator indicator, determine that the user equipment shall remain connected to the SGSN in the target PS domain when the CS operator is the same as the target PS operator.

According to a fourth aspect, the object is achieved by a MME for handling connections to a user equipment. The MME is associated with a source PS operator and with a user equipment. The MME comprises information about the CS/PS coordination indicator and the CS operator indicator. The MME comprises a receiver which is configured to receive a context request from the SGSN. The MME comprises a sender which is configured to send a context response to the SGSN in response to the context request. The context response comprises the CS/PS coordination indicator and the CS operator indicator enabling the SGSN to handle connections to the user equipment.

Thanks to the CS/PS coordination indicator and the CS operator indicator, the same CN operator will always serve the user equipment in the CS domain and the target PS domain, and thereby an improved and simplified communications network is provided.

Embodiments herein afford many advantages, of which a non-exhaustive list of examples follows:

In conventional networks, the same CN operator always serves the user equipment in CS and PS domains. In a shared network, supporting user equipments shall behave as user equipments in conventional networks with respect to registration with CS and PS domains. In some configurations a voice and data user equipment doing CSFB or SRVCC from LTE to 2G/3G may receive service from different operators in the PS and the CS domain. With the embodiments herein, it is guaranteed that the Third Generation Partnership Project (3GPP) requirement is fulfilled and that the same CN operator always serves the user equipment in CS and PS domains.

Another advantage of the embodiments herein is that the safety aspect of the communications network is improved. Furthermore, another advantage is that the embodiments herein make it easier for the operator in charging issues. Another advantage is that the embodiments herein have only impact on the SGSN and the MME, which is only two of several nodes in a communications network.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating embodiments of a communications network.

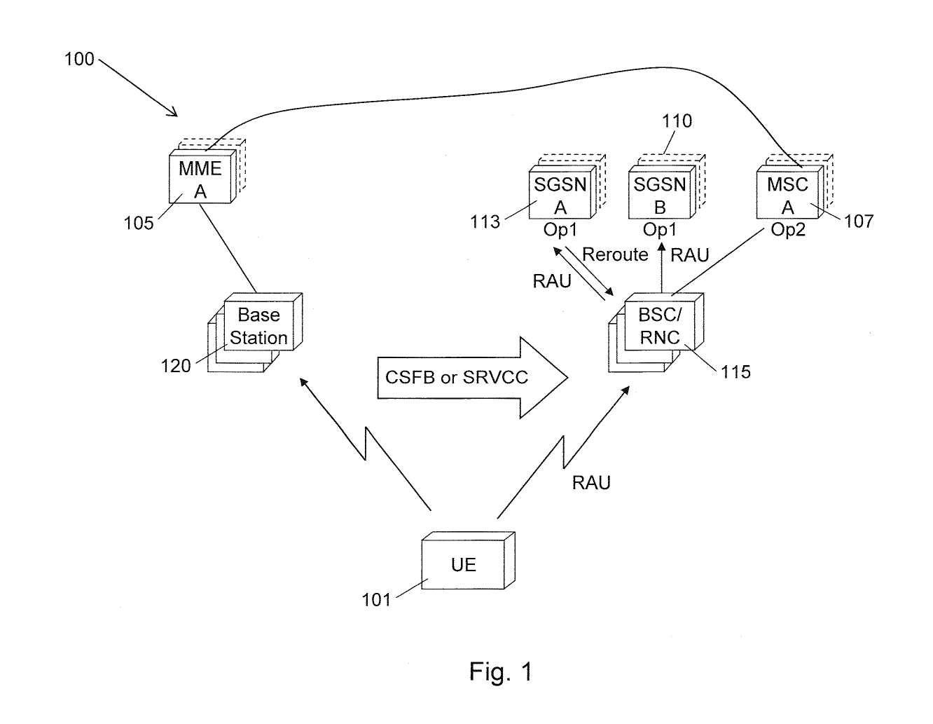

FIG. 2 is a flow chart illustrating embodiments of a method.

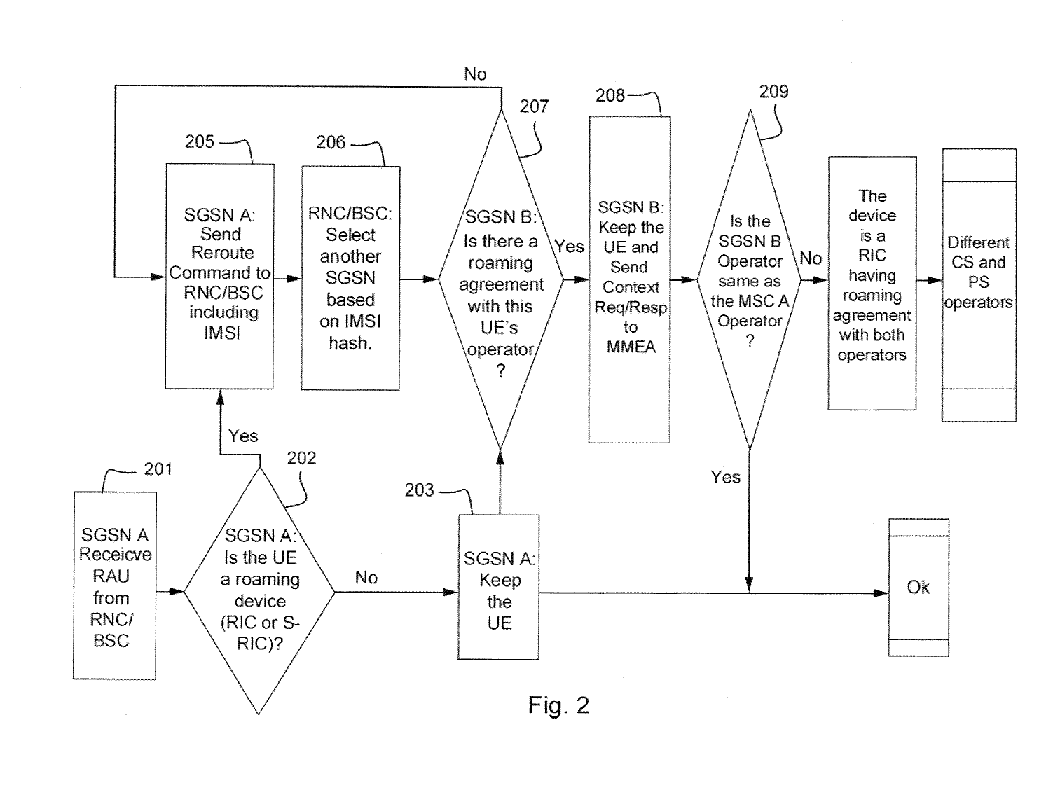

FIG. 3 is a schematic block diagram illustrating embodiments of a communications network.

FIG. 4 is a flow chart illustrating embodiments of a method.

FIG. 5 is a flow chart illustrating embodiments of a method in a SGSN.

FIG. 6 is a flow chart illustrating embodiments of a method in a RNC/BSC.

FIG. 7 is a flow chart illustrating embodiments of a method in a SGSN.

FIG. 8 is a schematic block diagram illustrating embodiments of a SGSN.

FIG. 9 is a flow chart illustrating embodiments of a method in a MME.

FIG. 10 is a schematic block diagram illustrating embodiments of a MME.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relates to session continuity from LTE to 2G/3G voice using CSFB or SRVCC in a shared network configuration.

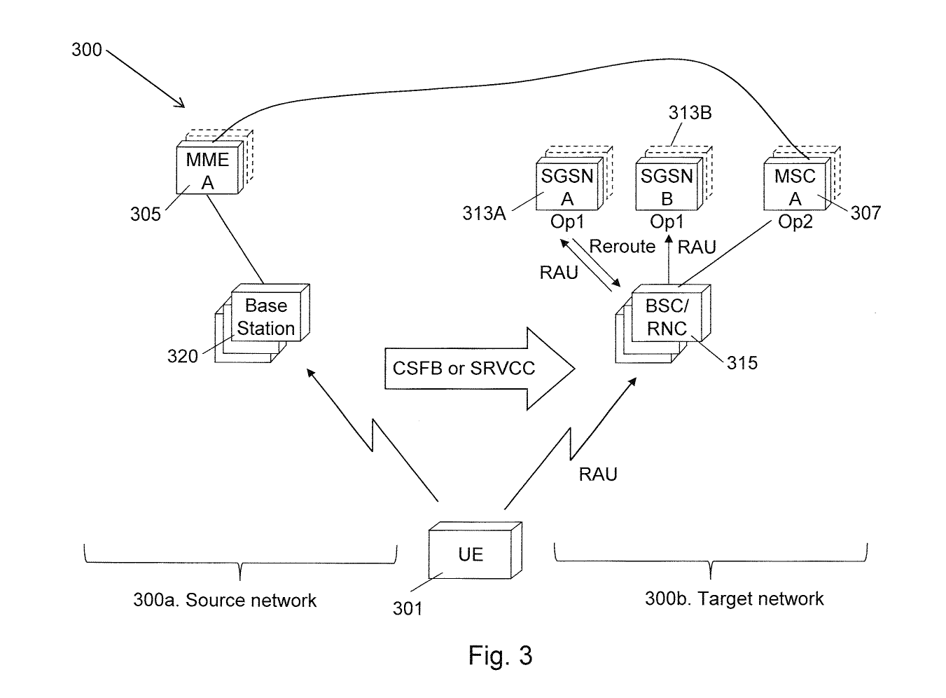

FIG. 3 depicts a communications network 300 in which embodiments herein may be implemented. The FIG. 3 only shows the necessary components related to the embodiments herein, but the skilled person will understand that the communications network 300 comprises further components such as e.g. a Serving Gateway (SGW) and a Packet Data Network (PDN) Gateway (PGW). The communications network 300 may in some embodiments apply to one or more radio access technologies such as for example LTE and 2G/3G. The communications network 300 comprises a source network 300a and a target network 300b.

The communications network 300 comprises a base station 320 serving a cell (not shown). The base station 320 may be a base station such as a NodeB, an eNodeB, or any other network unit capable to communicate over a radio carrier with a user equipment 301 being present in the cell. The user equipment 301 is referred to as UE in some of the drawings.

The user equipment 301 may be any suitable communication device or computational device with communication capabilities capable to communicate with the base station 320 over a radio channel, for instance but not limited to user equipment, mobile phone, smart phone, personal digital assistant (PDA), tablet computer, Machine to Machine (M2M) device, laptop, MP3 player or portable DVD player (or similar media content user equipments), digital camera, or even stationary user equipments such as a PC. A PC may also be connected via a mobile station as the end station of the broadcast/multicast media. The user equipment 301 may also be an embedded communication device in e.g. electronic photo frames, cardiac surveillance equipment, intrusion or other surveillance equipment, weather data monitoring systems, vehicle, car or transport communication equipment, etc.

The user equipment 301 is camping in LTE, i.e. it is located in a source PS domain, and is served by an operator A. The user equipment 301 is connected to a MME A 305 and it is registered with an MSC A 307. A RNC/BSC 315 is connected to the MSC A 307. The user equipment 301 moves, due to CSFB or SRVCC, from the source PS domain 300a to a target domain 300b, which provides PS and CS services. In the CS domain, the user equipment 301 is registered with the MSC A 307. In this example, operator A provides PS services and operator B provides CS services, and therefore the A and B used in relation to the network nodes refers to the operators A and B. The user equipment 301 sends a Routing Area Update (RAU) message to a SGSN A 313A. The user equipment 301 has a roaming agreement with both operators A and B. In the target network 300b, the user equipment 301 accesses the same BSC/RNC 315. In the following, the reference number 313A is used to refer to an SGSN A associated with operator A and the reference number 313B is used to refer to an SGSN B associated with operator B. The reference number 313 is used to refer to an SGSN in general, regardless of which operator it is associated with. The LTE part of the communications network 300 may be seen as one part, and the shared network is seen as another part of the communications network 300.

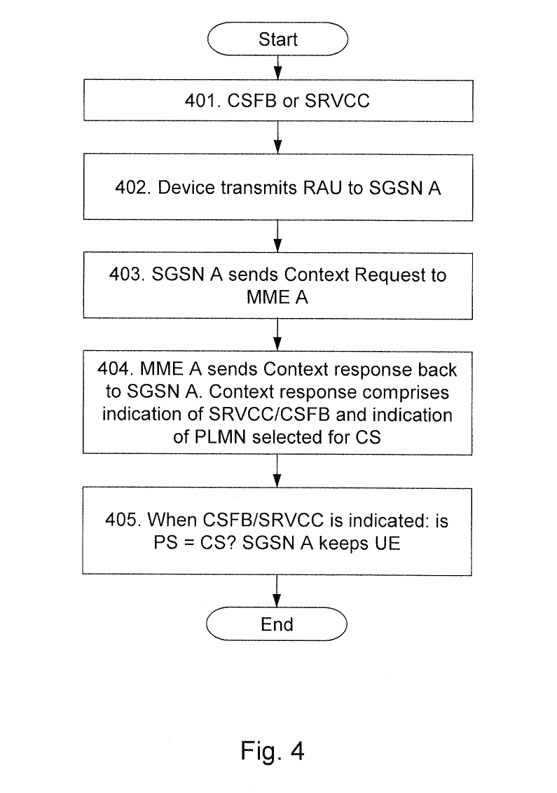

FIG. 4 illustrates embodiments of a method. Before the method takes place, the user equipment 301 has moved from a source network 300a to a target network 300b. The target network 300b provides both CS and PS services to the user equipment 301. In the following, the letter A refers to the operator A providing PS services and the letter B refers to operator B providing CS services. The method comprises the following steps, which steps may be performed in any suitable order:

### Step 401

CSFB or SRVCC is done.

### Step 402

The user equipment 301 transmits a RAU to the SGSN A 313A.

### Step 403

The SGSN A 313A sends a Context Request to the MME A 305.

### Step 404

The MME A 305 sends a Context response back to the SGSN A 313A. In the Context response there is an indication of SRVCC/CSFB and also an indication of the operator selected for CS, e.g. the PLMN ID. The operator indication indicates the operator of the MSC A 307, e.g. operator A. The indication of SRVCC/CSFB may be referred to as a CS/PS coordination indicator. The other indicator may be referred to as a CS operator indicator.

### Step 405

When CSFB/SRVCC is indicated and the operator for CS is the same as the operator for PS, the SGSN A 313A shall not send Reroute Command with a CS/PS Coordination Required-message back to the BSC/RNC 315, but it shall keep the user equipment 301 (new SGSN behaviour). If the operator selected for CS is not the same as for PS then SGSN A 313A shall send a Reroute Command back to the BSC/RNC 315 with Cause code #15 No suitable cells in this Location Area (LA) and comprising the IMSI associated with the user equipment.

Note that the BSC/RNC 315 is the same for the operator A and operator B. Furthermore, note that the IMSI is significant in the message received by the SGSN A 313A from the RNC/BSC 315, because if the IMSI is not comprised, it is the first time the RNC/BSC 315 sends the message to any SGSN 313, and CS/PS Coordination may be started. In this case the SGSN A 313A may be selected again. If the IMSI is comprised, the RNC/BSC 315 retries the SGSN selection based on IMSI hashing and the selected SGSN 313 shall accept or reject the user equipment 301 based on roaming agreements.

The embodiments herein are based on preventing the SGSN A 313A to return the Reroute Command message to the RNC/BSC 315. This shall be done only in case the user equipment 301 changed from LTE to the UTRAN/GERAN due to SRVCC or CSFB, not in case the user equipment 301 has done an IRAT PSHO, in such case the CS/PS coordination may be done according to current 3GPP specifications.

The SGSN A 313A needs a behaviour such that when the user equipment 301 makes a RAU towards the SGSN A 313A, the SGSN A 313A may, after it has received the Context Response from the MME A 305, check if the CS/PS coordination indicator is comprised, and also check the CS operator indicator comprised. If the information is comprised, the SGSN A 313A shall check if the operator for CS as indicated from the MME A 305 is the same operator as the operator for PS, and if so the user equipment 301 shall be kept by the SGSN A 313A otherwise the SGSN A 313A shall send a Reroute Command to the RNC/BSC 315, in order to reroute the RAU towards another SGSN.

In case the first SGSN A 313A rerouted the RAU, the RNC/BSC 315 will select another SGSN B 313B and send the RAU there. This new SGSN B 310B will behave in exactly the same way as the first SGSN A 313A. It will send a Context Request to the MME A 305 and check if SRVCC/CSFB has been done and also check the CS operator indicator. The Rerouting may go on until a suitable SGSN 313 is found or until all SGSNs 313 are exhausted.

Note, it is not efficient that each SGSN 313 receiving the RAU in the reroute procedure shall send the Context Request to the MME A 305. An optimization of the procedure may be done such that the first SGSN A 313A in the sequence comprises the CS/PS coordination indicator and also the CS operator indicator received from the MME A 305 in the Reroute Command sent back to the RNC/BSC 315. The RNC/BSC 315 may then comprise these indicators when sending the RAU to the next SGSN 313, and then this SGSN 313 may check these indicators directly without sending the Context Request to the MME A 305. The SGSN A 313A will contact the MME A 305 only if the SGSN A 313A accepts the user equipment 301.

A further optimization when using pool and equal service areas is to use the synchronization of NRI and MMEC to get the RNC/BSC 315 to route the RAU to the correct SGSN 313 in the first try. This is possible already today for a BSC, but for an RNC it requires that the NRI is used regardless of the PLMN where it was allocated.

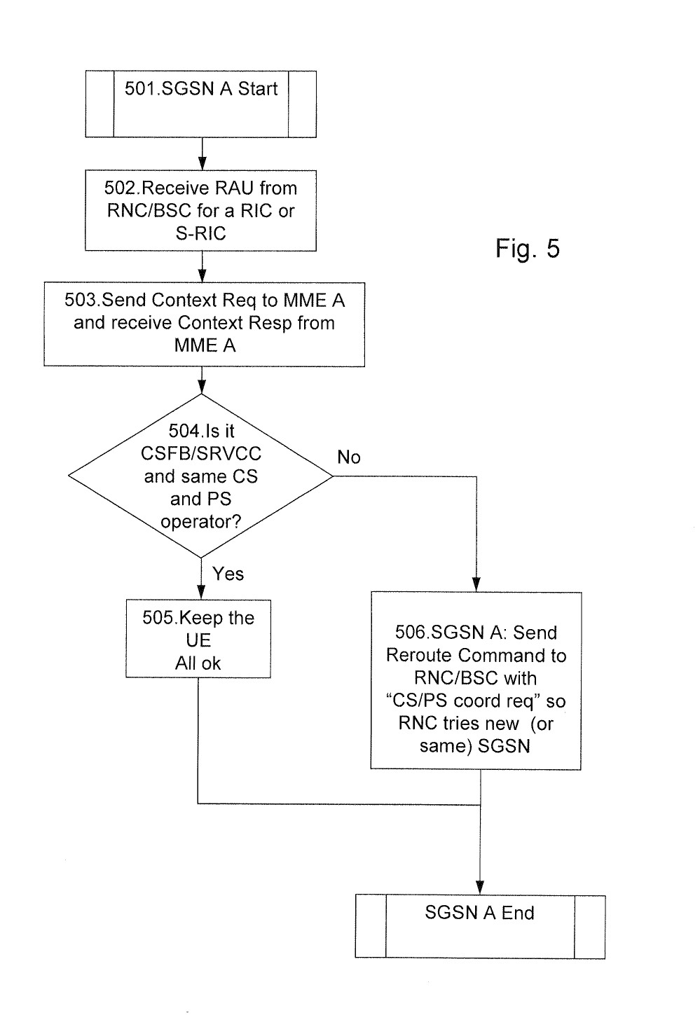

FIG. 5 is a flow chart illustrating embodiments of a method in the SGSN associated with a PS operator A. The user equipment 301 is camping in LTE and is served by the operator A, providing PS services. The user equipment 301 has a roaming agreement with both operators A and B. The user equipment 301 is connected to an MME. Note that only two operators, A and B are only used as an example. Any other suitable number of operators is also applicable.

The method comprises the following steps, which steps may be performed in any suitable order:

### Step 501

The method in the SGSN A 313A starts when a CSFB or SRVCC without PS HO is triggered.

### Step 502

This step corresponds to step 402 in FIG. 4. The SGSN A 313A receives a RAU from the RNC/BSC 315 for a RIC or S-RIC user equipment 301.

### Step 503

This step corresponds to step 403 and step 404 in FIG. 4. The SGSNA 313A sends a Context Request to the MME A 305 and receives a Context Response in return. The MME A 305 is in the source domain.

### Step 504

This step corresponds to step 405 in FIG. 4. The SGSN A 313A checks whether a CSFB or SRVCC has been performed and whether CS operator is the same as the PS operator. If the CSFB or SRVCC has been performed and the CS operator is the same as the PS operator, indicated with “yes” in FIG. 5, the method proceeds to step 505. If the CSFB or SRVCC has not been performed and the CS operator different from the PS operator, indicated with “no” in FIG. 5, the method proceeds to step 506.

### Step 505

This step corresponds to step 405 in FIG. 4. If the CSFB or SRVCC has been performed and the CS operator is the same as the PS operator, indicated with “yes” in FIG. 5, the SGSN A 313A keeps the user equipment 301, and everything is ok.

### Step 506

This step corresponds to step 405 in FIG. 4. If the CSFB or SRVCC has not been performed and the CS operator is different from the PS operator, indicated with “no” in FIG. 5, the SGSN A 313A sends a Reroute Command to the RNC/BSC 315 with “Cause code #15 No suitable cells in this LA”, and the RNC/BSC 315 tries another SGSN.

A user equipment 301 that is not able to be served the SGSN never returns CC “CS/PS coordination required”.

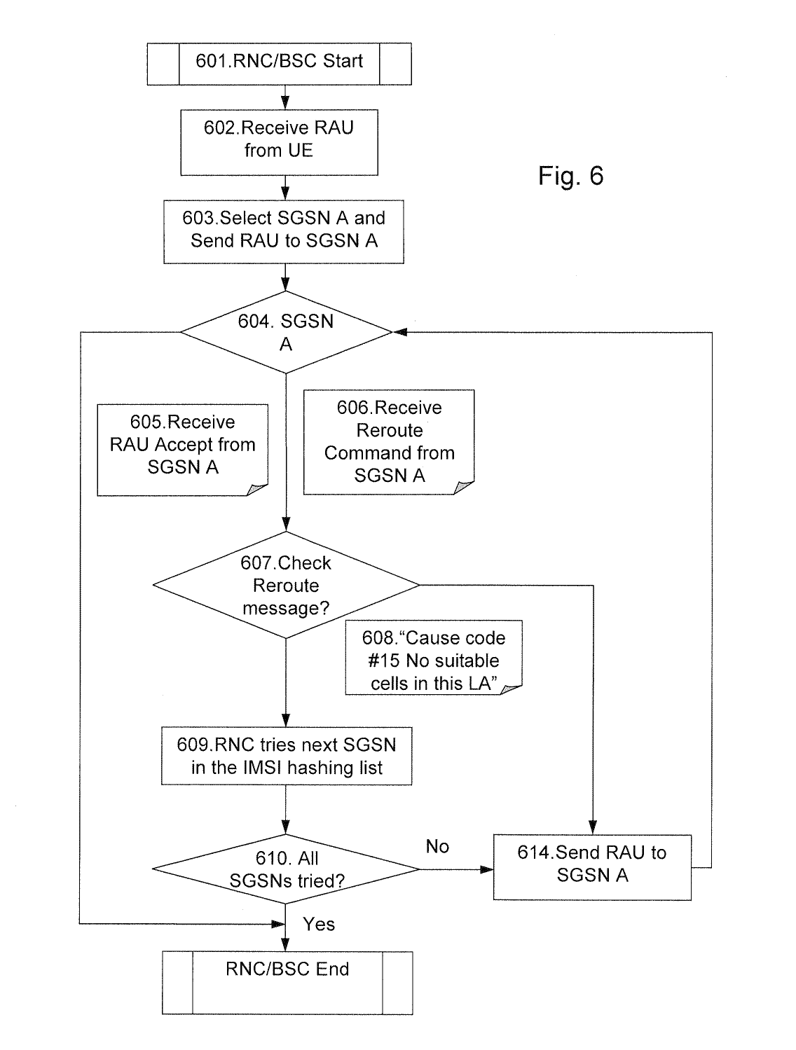

FIG. 6 is a flow chart illustrating the method in the RNC/BSC 315. The method comprises the following steps, which steps may be performed in any suitable order:

### Step 601

The RNC/BSC 315 starts its operation.

### Step 602

The RNC/BSC 315 receives the RAU from the user equipment 301.

### Step 603

This step corresponds to step 402 in FIG. 4 and step 502 in FIG. 5. The RNC/BSC 315 selects the SGSN 313 and sends a RAU to the SGSN A 313A.

### Step 604

This step corresponds to step 405 in FIG. 4 and step 504 in FIG. 5. The RNC/BSC 315 receives a message from the SGSN A 313A.

### Step 605

The message received from the SGSN A 313A is a RAU accept, then the method ends, as illustrated with the arrow on the left side of box 604.

### Step 606

The message received from the SGSN A 313A is a reroute command, then the method proceeds, as illustrated with the arrow on the right side of box 604.

### Step 607

The RNC/BSC 315 checks the Reroute message from the SGSN A 313A.

### Step 608

The reroute message from the SGSN A 313A checked in step 607 is a “Cause code #15 No suitable cells in this LA”, the method proceeds to step 609.

### Step 609

The RNC/BSC 315 tries the next SGSN 313 in the IMSI hashing list.

### Step 610

The RNC/BSC 315 checks whether all SGSNs 313 are tried. If all SGSNs 313 are tried, indicated with “yes” in FIG. 6, the method ends. If not all SGSNs 313 are tried, indicated with “no” in FIG. 6, the method proceeds to step 614.

### Step 614

This step corresponds to step 402 in FIG. 4 and to step 502 in FIG. 5. The RNC/BCS 315 sends a RAU to the SGSN A 313A.

Note that the RNC/BSC algorithm is the way it works when the user equipment 301 is a RIC or S-RIC, a non-roaming user equipment will not be rerouted.

Furthermore, note that in case all SGSNs 313 have been tried without success, the CS call is continued, while the PS call is unsuccessful. To get out of loop with repeated RAU requests from the user equipment 301, the MME A 305 may only send the CSFB indicator for a short time after CSFB or SRVCC from LTE.

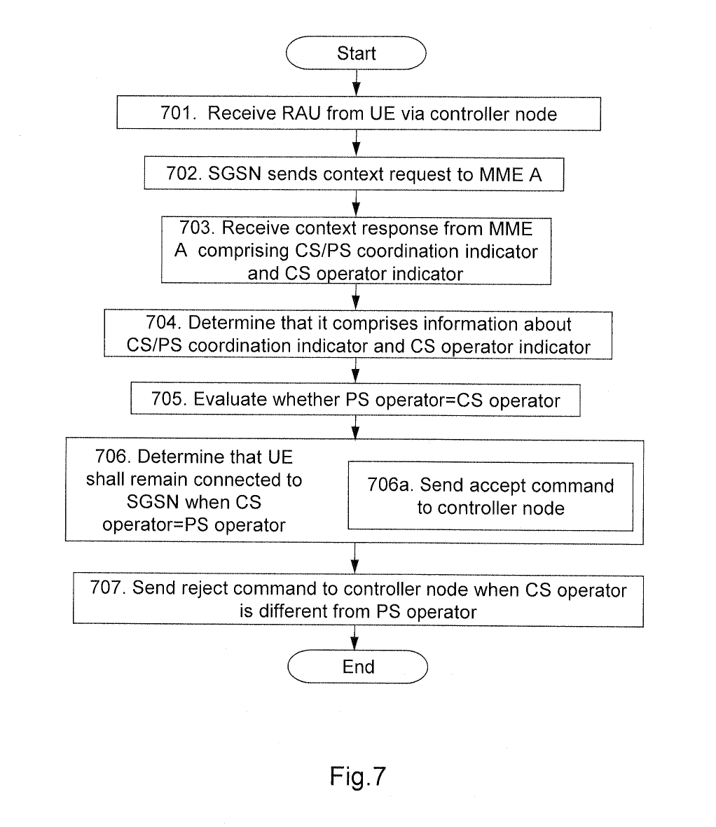

The method described above will now be described seen from the perspective of the SGSN 313. FIG. 7 is a flowchart describing the present method in the SGSN 313. The SGSN 313 is connected to a user equipment 301. The user equipment 301 has moved from a PS domain to a CS domain due to SRVCC or due to CSFB. In some embodiments, the user equipment 301 has not performed an IRAT PSHO. The SGSN 313 may be the SGSN A 313A.

In some embodiments, the SGSN 313 is associated to the PS operator and connected to the user equipment 301. The user equipment 301 when being in the CS domain is associated with a voice call connected to an MSC A 307. The MSC A 307 is associated to the CS operator, and the user equipment 301 has been moved from the MME A 305 in the PS domain, wherein being associated to said MSC A 307, to both another PS domain and to the CS domain.

In some embodiments, the user equipment 301 receives a voice call when being in the PS domain and moves to the CS domain. In some embodiments, the CS domain and the PS domain is a shared network.

The method comprises the further steps to be performed by SGSN 313, which steps may be performed in any suitable order:

### Step 701

This step corresponds to step 402 in FIG. 4, to step 502 in FIG. 5 and step 603 in FIG. 6. In some embodiments, the SGSN 313 receives a RAU message from the user equipment 301 via the controller node 315. In some embodiments, the controller node 315 is a RNC or a BSC.

### Step 702

This step corresponds to step 403 in FIG. 4 and step 503 in FIG. 5. In some embodiments, the SGSN 313 sends a context request to an MME A 305. The MME A 305 is associated with the user equipment 301.

### Step 703

This step corresponds to step 404 in FIG. 4 and step 503 in FIG. 5. In some embodiments, the SGSN 313 receives a context response from the MME A 305 in response to the context request. The context response may comprise the CS/PS coordination indicator and the CS operator indicator. In some embodiments, the CS/PS indicator and the CS operator indicator are information elements. In some embodiments, the CS operator indicator is based on a PLMN ID. The PLMN ID is used by both the PS operator and the CS operator. Note that the PLMN ID is only an example of a CS operator indicator. Any other suitable CS operator indicator may also be used instead of the PLMN ID. The PLMN ID may be a Common PLMN, i.e. the same PLMN is used by all sharing operators.

### Step 704

This step corresponds to step 405 in FIG. 4 and step 504 in FIG. 5. The SGSN 313 determines that it comprises information about a CS/PS coordination indicator and a CS operator indicator. In some embodiments, the CS/PS coordination indicator is a fixed CS/PS coordination indicator. In some embodiments, the CS/PS coordination indicator is based on the user equipment 301 changing from LTE to UTRAN/GERAN due to CSFB or SRVCC.

### Step 705

This step corresponds to step 405 in FIG. 4 and step 504 in FIG. 5. The SGSN 313 evaluates whether a PS operator is the same as a CS operator when the SGSN 313 is determined to comprises the CS/PS coordination indicator and the CS operator indicator in step 704. In some embodiments, the PS operator provides data services and the CS operator provides voice services.

### Step 706

This step corresponds to step 405 in FIG. 4 and step 505 in FIG. 5. The SGSN 313 determines that the user equipment 301 shall remain connected to the SGSN 313 in the domain when the CS operator is the same as the PS operator.

### Step 706a

This step corresponds to step 405 in FIG. 4 and step 505 in FIG. 5. In some embodiments, the SGSN 313 sends an accept command to the controller node 315 when it is determined that the user equipment 301 shall remain connected to the SGSN 313 in the PS domain.

### Step 707

This step corresponds to step 405 in FIG. 4 and step 506 in FIG. 5. The SGSN 313 sends a reject command to the controller node 315 when the CS operator is different from the PS operator. In some embodiments, the reject command comprises a reroute indicator. In some embodiments, the reroute indicator comprises information about a Cause code #15 No suitable cells in this LA.

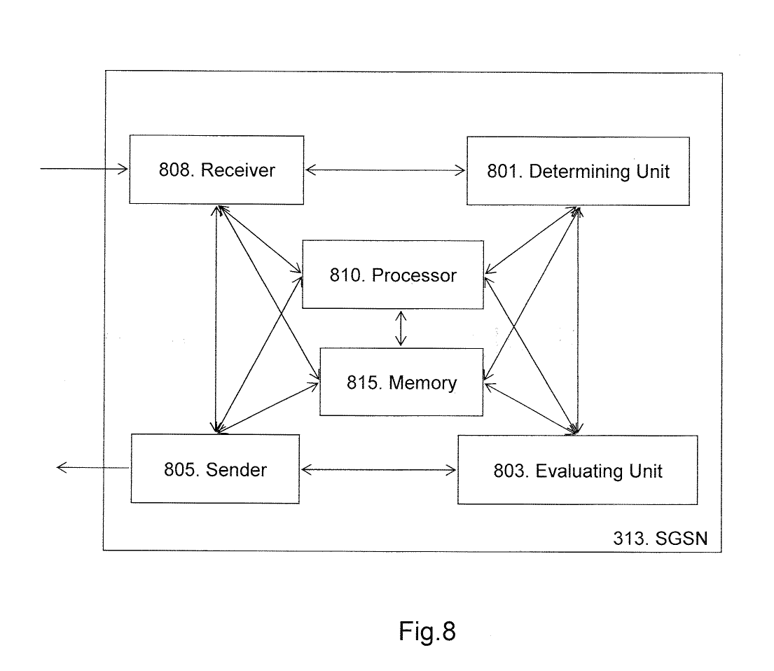

To perform the method steps shown in FIG. 7 the SGSN 313 comprises an arrangement as shown in FIG. 8. The SGSN 313 is connected to a user equipment 301. The user equipment 301 has moved from a PS domain to a CS domain due SRVCC or due CSFB. In some embodiments, the CS domain and the PS domain is a shared network. In some embodiments, the user equipment 301 has not performed an IRAT PSHO.

In some embodiments, the SGSN 313 is associated to the PS operator and connected to the user equipment 301. The user equipment 301 when being in the CS domain is associated with a voice call connected to an MSC A 307. The which MSC A 307 is associated to the CS operator, and the user equipment 301 has been moved from the MME A 305 in the PS domain, wherein being associated to said MSC A 307, to both another PS domain and to the CS domain. In some embodiments, the PS operator provides data services and the CS operator provides voice services.

In some embodiments, the user equipment 301 receives a voice call when being in the PS domain and moves to the CS domain.

The SGSN 313 comprises a determining unit 801 configured to determine that the SGSN 313 comprises information about a CS/PS coordination indicator and a CS operator indicator. The determining unit 801 is further configured to determine that the user equipment 301 shall remain connected to the SGSN 313 in the PS domain when the CS operator is the same as the PS operator. In some embodiments, the CS/PS coordination indicator is a fixed coordination indicator.

The SGSN 313 comprises an evaluating unit 803 configured to evaluate whether a PS operator is the same as a CS operator when the SGSN 313 is determined to comprises the CS/PS coordination indicator and the CS operator indicator. In some embodiments, the CS indicator and the operator indicator are information elements. In some embodiments, the operator indicator is based on a PLMN ID. The PLMN ID may be used by both the PS operator and the CS operator.

The SGSN 313 comprises a sender 805 configured to send a reject command to the controller node 315 when the CS operator is different from the PS operator. In some embodiments, the sender 805 is further configured to send a context request to an MME A 305. The MME A 305 is associated with the user equipment 301. In some embodiments, the sender 805 is further configured to send an accept command to the controller node 315 when it is determined that the user equipment 301 shall remain connected to the SGSN 313 in the PS domain. In some embodiments, the reject command comprises a reroute indicator. In some embodiments, the reroute indicator comprises information about a Cause code #15 No suitable cells in this LA.

In some embodiments, the SGSN 313 comprises a receiver 808 configured to receive a routing area update message from the user equipment 301 via the controller node 315. In some embodiments, the receiver 808 is further configured to receive a context response from the MME A 305 in response to the context request. In some embodiments, the context response comprises the CS/PS coordination indicator and the CS operator indicator. In some embodiments, the CS/PS coordination indicator is based on the user equipment 301 changing from LTE to UTRAN/GERAN due to CSFB or SRVCC. In some embodiments,

the controller node 315 is a RNC or a BSC.

The SGSN 313 may further comprise a memory 815 comprising one or more memory units. The memory 815 is arranged to be used to store data, received data streams, RAU, the CS/PS coordination indication, the CS operator indication, threshold values, time periods, configurations, schedulings, and applications to perform the methods herein when being executed in the SGSN 313.

Those skilled in the art will also appreciate that the receiver 808, the sender 805, the determining unit 801 and the evaluating unit 803 described above may refer to a combination of analog and digital circuits, and/or one or more processors configured with software and/or firmware, e.g. stored in a memory, that when executed by the one or more processors. One or more of these processors, as well as the other digital hardware, may be comprised in a single application-specific integrated circuit (ASIC), or several processors and various digital hardware may be distributed among several separate components, whether individually packaged or assembled into a system-on-a-chip (SoC).

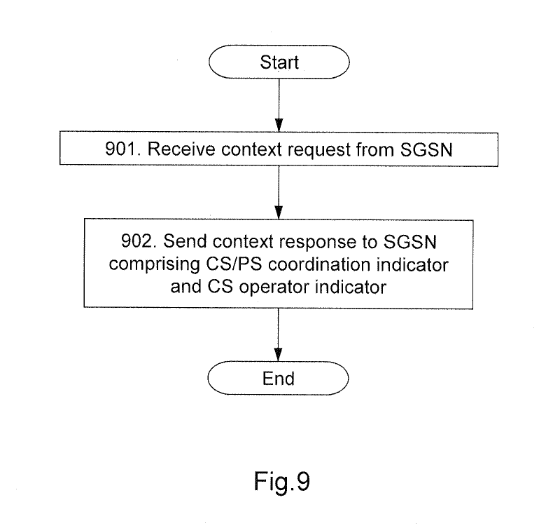

The method described above will now be described seen from the perspective of the MME A 305. The MME A 305 is associated with a PS operator and with a user equipment 301. The MME A 305 comprises information about a CS/PS coordination indicator and a CS operator indicator. FIG. 9 is a flowchart describing the present method in the MME A 305, which steps may be performed in any suitable order:

### Step 901

This step corresponds to step 503 in FIG. 5. The MME A 305 receives a context request from the SGSN 313.

### Step 902

This step corresponds to step 503 in FIG. 5. The MME A 305 sends a context response to the SGSN 313 in response to the context request. The context response comprises the CS/PS coordination indicator and the CS operator indicator.

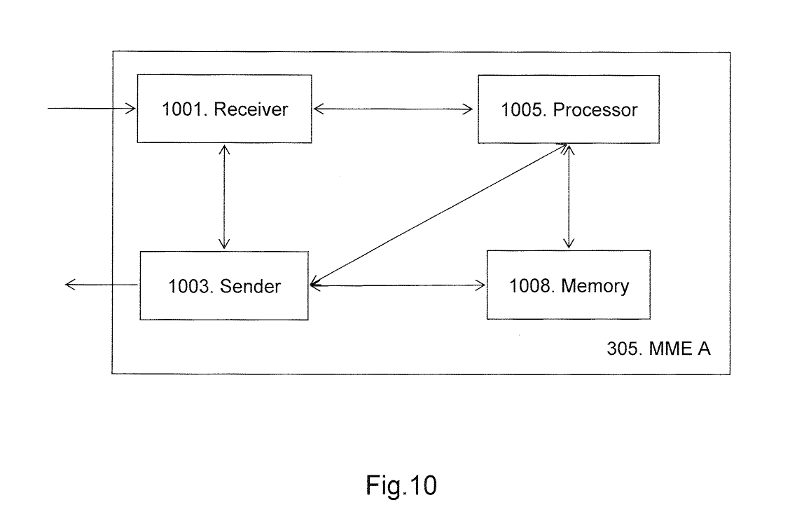

To perform the method steps shown in FIG. 9 the MME A 305 comprises an arrangement as shown in FIG. 10. The MME A 305 is associated with a PS operator and with a user equipment 301. The MME A 305 comprises information about a CS/PS coordination indicator and a CS operator indicator. The MME A 305 comprises a receiver 1001 configured to receive a context request from the SGSN 313. The MME A 305 comprises a sender 1003 configured to send a context response to the SGSN 313 in response to the context request. The context response comprises the CS/PS coordination indicator and the CS operator indicator.

The MME A 305 may further comprise a memory 1008 comprising one or more memory units. The memory 1008 is arranged to be used to store data, received data streams, CS coordination indicator, CS operator indicator, threshold values, time periods, configurations, schedulings, and applications to perform the methods herein when being executed in the MME A 305.

Those skilled in the art will also appreciate that the receiver 1001 and the sender 1003 described above may refer to a combination of analog and digital circuits, and/or one or more processors configured with software and/or firmware, e.g. stored in a memory, that when executed by the one or more processors. One or more of these processors, as well as the other digital hardware, may be comprised in a single application-specific integrated circuit (ASIC), or several processors and various digital hardware may be distributed among several separate components, whether individually packaged or assembled into a system-on-a-chip (SoC).

The present mechanism in a communication network 300 may be implemented through one or more processors, such as a processor 810 in the SGSN 313 depicted in FIG. 8 and a processor 1005 in the MME A 305 depicted in FIG. 10, together with computer program code for performing the functions of the embodiments herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the embodiments herein when being loaded into the SGSN 313 and/or MME 305. One such carrier may be in the form of a CD ROM disc. It is however feasible with other data carriers such as a memory stick. The computer program code may furthermore be provided as pure program code on a server and downloaded to the SGSN 313 and/or MME A 305.

The embodiments herein are not limited to the above described embodiments. Various alternatives, modifications and equivalents may be used. Therefore, the above embodiments should not be taken as limiting the scope of the embodiments.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

1. A method in a Serving General packet radio service Support Node, SGSN, for handling connections to a user equipment, wherein the SGSN is connected to the user equipment, wherein the user equipment has moved from a source Packet Switched, PS, domain to a Circuit Switched, CS, domain due to a Single Radio Voice Call Continuity, SRVCC, or due to a Circuit Switched FallBack, CSFB, wherein a target PS domain is associated with a target PS operator and wherein the CS domain is associated with a CS operator, the method comprising:
when the SGSN comprises information about a CS/PS coordination indicator and a CS operator indicator, determining that the user equipment shall remain connected to the SGSN in the target PS domain when the CS operator is the same as the target PS operator.

2. The method according to claim 1, further comprising:
determining that the SGSN comprises information about the CS/PS coordination indicator and the CS operator indicator; and
evaluating whether the target PS operator is the same as the CS operator when the SGSN is determined to comprise the CS/PS coordination indicator and the CS operator indicator.

3. The method according to claim 1, further comprising:
sending a reject command to a controller node when the CS operator is different from the target PS operator.

4. The method according to claim 1, further comprising:
receiving a routing area update message from the user equipment via a controller node.

5. The method according to claim 1, further comprising:
sending a context request to a Mobility Management Entity, MME A, which MME A is associated with the user equipment; and
receiving a context response from the MME A in response to the context request, wherein the context response comprises the CS/PS coordination indicator and the CS operator indicator.

6. The method according to claim 1, further comprising:
sending an accept command to a controller node when it is determined that the user equipment shall remain connected to the SGSN in the target PS domain, which accept command is a response to the routing area update message.

7. The method according to claim 3, wherein the reject command comprises a reroute indicator, wherein the reroute indicator comprises information about a Cause code #15 No suitable cells in this Location Area, LA.

8. The method according to claim 1, wherein the SGSN is associated to the target PS operator and connected to the user equipment, wherein the user equipment, when being in the CS domain, is associated with a voice call connected to a Mobile Switching Center, MSC A, which MSC A is associated to the CS operator, and wherein the user equipment has been moved from the MME A in the source PS domain, when being associated to said MSC A, to both the target PS domain and to the CS domain.

9. The method according to claim 1, wherein the user equipment receives a voice call when being in the source PS domain and moved to the CS domain.

10. The method according to claim 1, wherein the CS/PS coordination indicator is based on the user equipment changing from Long Term Evolution, LTE, to Universal Terrestrial Radio Access Network/Global system for mobile communications Enhanced data for global evolution Radio Access Network, UTRAN/GERAN, due to the CSFB or the SRVCC.

11. The method according to claim 1, wherein the CS/PS operator indicator is based on a Public Land Mobile Network IDentification, PLMN ID, which PLMN ID is used by both the target PS operator and the CS operator.

12. The method according to claim 1, wherein the user equipment has not performed an Inter Radio Access Technology Packet Switched HandOver, IRAT PSHO.

13. The method according to claim 1, wherein the target PS operator provides data services and the CS operator provides voice services.

14. A method in a Mobility Management Entity, MME A, for handling connections to a user equipment, which MME A is associated with a source Packet Switched, PS, operator and with a user equipment, the MME A comprises information about a Circuit Switched, CS/PS coordination indicator and a CS operator indicator, the method comprising:
receiving a context request from a Serving General packet radio service Support Node, SGSN;
sending a context response to the SGSN in response to the context request, wherein the context response comprises the CS/PS coordination indicator and the CS operator indicator enabling the SGSN to handle connections to the user equipment.

15. A Serving General packet radio service Support Node, SGSN, for handling connections to a user equipment, wherein the SGSN is configured to be connected to a user equipment, wherein the user equipment is configured to be moved from a source Packet Switched, PS, domain to a Circuit Switched, CS, domain due to a Single Radio Voice Call Continuity, SRVCC, or due to a Circuit Switched FallBack, CSFB, wherein a target PS domain is associated with a target PS operator and wherein the CS domain is associated with a CS operator, the SGSN comprises:
a determining unit configured to, when the SGSN comprises information about a CS/PS coordination indicator and a CS operator indicator, determine that the user equipment shall remain connected to the SGSN in the target PS domain when the CS operator is the same as the target PS operator.

16. The SGSN according to claim 15, wherein the determining unit is further configured to determine that the SGSN comprises information about the CS/PS coordination indicator and the CS operator indicator; and wherein the SGSN further comprises:
an evaluating unit configured to evaluate whether the target PS operator is the same as the CS operator when the SGSN is determined to comprise information about the CS/PS coordination indicator and the CS operator indicator.

17. The SGSN according to claim 15, further comprising:
a sender configured to send a reject command to a controller node when the CS operator is different from the target PS operator.

18. The SGSN according to claim 15, further comprising:
a receiver configured to receive a routing area update message from the user equipment via a controller node.

19. The SGSN according to claim 17, wherein the sender is further configured to send a context request to an Mobility Management Entity, MME A, which MME A is associated with the user equipment; and wherein the receiver is further configured to receive a context response from the MME A in response to the context request, wherein the context response comprises the CS/PS coordination indicator and the CS operator indicator.

20. The SGSN according to claim 15, wherein the sender is further configured to send an accept command to a controller node when it is determined that the user equipment shall remain connected to the SGSN in the target PS domain, which accept command is a response to the routing area update message.

21. The SGSN according to claim 15, wherein the reject command comprises a reroute indicator, wherein the reroute indicator comprises information about a Cause code #15 No suitable cells in this LA.

22. The SGSN according to claim 15, wherein the SGSN is configured to be associated to the PS operator and connected to the user equipment, wherein the user equipment, when being in the CS domain, is associated with a voice call connected to a Mobile Switching Center, MSC A, which MSC A is associated to the CS operator, and wherein the user equipment is configured to have been moved from the MME A in the source PS domain, when being associated to said MSC A, to both the target PS domain and to the CS domain.

23. The SGSN according to claim 15, wherein the user equipment is configured to receive a voice call when being in the source PS domain and to move to the CS domain.

24. The SGSN according to claim 15, wherein the CS/PS coordination indicator is based on the user equipment changing from Long Term Evolution, LTE, to Universal Terrestrial Radio Access Network/Global system for mobile communications Enhanced data for global evolution Radio Access Network, UTRAN/GERAN due to the CSFB or the SRVCC.

25. The SGSN according to claim 15, wherein the CS/PS operator indicator is based on a Public Land Mobile Network IDentification, PLMN ID, which PLMN ID is used by both the PS operator and the CS operator.

26. The SGSN according to claim 15, wherein the user equipment has not performed an Inter Radio Access Technology Packet Switched HandOver, IRAT PSHO.

27. The SGSN according to claim 15, wherein the PS operator is configured to provide data services and the CS operator is configured to provide voice services.

28. A Mobility Management Entity, MME A for handling connections to a user equipment, which MME A is associated with a source Packet Switched, PS, operator and with a user equipment, the MME A comprises information about a Circuit Switched, CS/PS coordination indicator and a CS operator indicator, the MME A comprises:
a receiver configured to receive a context request from a Serving General packet radio service Support Node, SGSN; and
a sender configured to send a context response to the SGSN in response to the context request, wherein the context response comprises the CS/PS coordination indicator and the CS operator indicator enabling the SGSN to handle connections to the user equipment.
